(19) United States
(12) Patent Application Publication
(10) Pub. No.: US 2023/0222309 A1
(43) Pub. Date: Jul. 13, 2023

(54) IDENTIFICATION TAG, IDENTIFICATION-TAG MANUFACTURING METHOD, IDENTIFICATION-TAG READING METHOD, AND ARTICLE WITH IDENTIFICATION TAG

(71) Applicant: Murata Manufacturing Co., Ltd., Nagaokakyo-shi (JP)

(72) Inventor: Satoshi NAGASO, Nagaokakyo-shi (JP)

(21) Appl. No.: 18/188,651

(22) Filed: Mar. 23, 2023

Related U.S. Application Data
(63) Continuation of application No. PCT/JP2021/034393, filed on Sep. 17, 2021.

(30) Foreign Application Priority Data
Sep. 30, 2020 (JP) 2020-165585

(51) Int. Cl. G06K 19/077

(52) U.S. Cl. CPC G06K 19/07758

(57) ABSTRACT

An identification tag that uses particles as tag information that includes a necking shape containing the particles as readable tag information.

### CROSS REERENCE TO RELATED APPLICATIONS

This application is a continuation of PCT Application No. PCT/JP2021/034393, filed Sep. 17, 2021, which claims priority to Japanese Patent Application No. 2020-165585, filed Sep. 30, 2020, the entire contents of each of which are hereby incorporated by reference in their entirety.

### TECHNICAL FIELD

The present invention relates to an identification tag, a method for producing an identification tag, a method for reading an identification tag, and an identification-tagged article.

### BACKGROUND

Japanese Patent Application JP 2009-516822 (hereinafter “Patent Literature 1”) discloses encoded microparticles that each include a first material including two or more separate segments aligned along an axis and a second material surrounding the first material, such that the segments are detectable through the second material, in which a code for the microparticle is provided.

Patent Literature 1 further describes using coding structures and gaps of the microparticles as code elements. As an example, an encoded microparticle is described in which segments with different lengths and gaps with the same length are alternately aligned.

Patent Literature 1 describes the microparticles can be used as major functional members of biochemical (or chemical) analysis systems or solution based arrays, biochips, DNA microarrays, and protein microarrays.

The coding structures described in Patent Literature 1 are manufactured by a semiconductor process, and a large-scale manufacturing apparatus is required. Therefore, there has been a demand for an identification tag that can be mass-produced by a simpler method and that can also provide a wide variety of tag types.

### SUMMARY OF THE INVENTION

Accordingly, it is an object of the present invention to provide an identification tag that can be mass-produced by a simple method and that can also provide a wide variety of tag types.

In an exemplary aspect, an identification tag is provided that uses particles as tag information. In this aspect, the identification tag includes a necking shape containing the particles as information to be read.

Moreover, in an exemplary aspect, a method is provided for producing an identification tag using particles as tag information. In this aspect, the method includes performing heat treatment of a composition containing the particles to generate a necking shape containing the particles.

Moreover, in an exemplary aspect, a method is provided for reading an identification tag that includes distinguishing a type of the identification tag by information on the necking shape included in the identification tag of the present invention.

Yet further, an exemplary aspect is provided for an identification-tagged article that includes an article with the identification tag attached thereto.

The exemplary aspects of the present invention provide the identification tag that can be mass-produced by a simple method and that can also provide a wide variety of identification tag types.

### BRIEF DESCRIPTION OF DRAWINGS

FIG. 1 is an electron micrograph of barium titanate particles as an example of metal oxide particles before heat treatment.

FIG. 2 is an electron micrograph of barium titanate particles including a necking shape after heat treatment.

FIG. 3 is a schematic view illustrating an example of correspondence between different heat treatment conditions and necking shapes.

FIG. 4 is a schematic view illustrating an example in which the necking shape illustrated in the upper right of FIG. 3 is analyzed by image processing.

FIG. 5 is a schematic view illustrating an example in which the necking shape illustrated in the lower right of FIG. 3 is analyzed by image processing.

FIG. 6 is a drawing illustrating an example in which a portion surrounded by a dotted line in the electron micrograph illustrated in FIG. 2 is binarized by image processing.

FIG. 7 is a schematic view illustrating an example in which a necking shape is divided using a watershed.

FIG. 8 is a schematic view illustrating an example in which a necking shape is divided using a watershed.

FIG. 9 is a schematic view illustrating an example in which luminance information is analyzed from an electron micrograph.

FIG. 10 is a schematic view illustrating an example in which luminance information is analyzed from an electron micrograph.

FIG. 11 is a schematic view illustrating an example of correspondence between different pretreatment conditions and heat treatment conditions, and a necking shape.

FIG. 12 is a schematic view illustrating an example of correspondence between different pretreatment conditions and heat treatment conditions, and a necking shape.

FIG. 13 is a perspective view schematically illustrating an example of an identification-tagged article.

FIG. 14 is a perspective view schematically illustrating an example of an identification-tagged article.

### DETAILED DESCRIPTION OF EMBODIMENTS

Hereinafter, an identification tag, a method for producing an identification tag, a method for reading an identification tag, and an identification-tagged article of the present invention will be described.

In general, it is noted that the present invention is not limited to the following configurations and modes, and changes can be appropriately applied thereto within a range not changing the gist of the present invention. The present invention also includes a combination of two or more of the individual preferred configurations and modes of the present invention described below.

In an exemplary aspect, the identification tag uses particles as tag information, and includes a necking (“necking”) shape containing the particles as information to be read, i.e., as readable tag information.

The necking shape is a shape of metal particles, metal oxide particles, metal nitride particles, or metal carbide particles.

In an exemplary aspect, the particles can be metal oxide particles. In this case, when an assembly, for example, a molded body or an aggregate of metal oxide particles is heated, a contact area between particles having a short inter-particle distance increases, so that the particles are joined together while coalescing. The particles in this joined state form the necking shape.

Although the necking shape typically refers to a constricted shape that is generated at a portion where particles are joined together, the present disclosure defines the necking shape to include those shapes having an appearance in a joined state that cannot be considered as a constricted shape anymore due to progress in joining. However, it is preferable that the necking shape has the constricted shape since it is easy to identify the necking shape having the constricted shape.

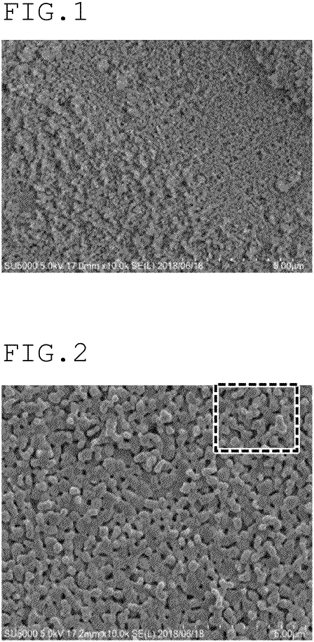

FIG. 1 is an electron micrograph of barium titanate particles as an example of metal oxide particles before heat treatment.

FIG. 2 is an electron micrograph of barium titanate particles including the necking shape after heat treatment.

FIG. 2 illustrates that the barium titanate particles after heat treatment are in a state where the particles are joined together. Such a shape in which the particles are joined together is the necking shape.

A behavior of the metal oxide particles joined by heat treatment changes depending on composition, particle sizes, and shapes of the metal oxide particles, heat treatment conditions, atmosphere conditions, and the like of the metal oxide particles (hereinafter, these conditions are also referred to as necking formation conditions). With the change in such a joining behavior, the necking shape containing the particles produced under the respective necking formation conditions also changes.

Since a producer of the identification tag who forms the necking shape knows under what necking formation conditions the necking shape has been obtained, a specific necking shape can be obtained by performing treatment under specific necking formation conditions.

On the other hand, it is not easy to clarify the necking formation conditions from the necking shape. Therefore, a third party who is not the producer of the identification tag cannot know under what necking formation conditions the necking shape has been obtained even by looking at the necking shape of the identification tag. Therefore, it is difficult for that third party person other than the producer of the identification tag to reproduce the necking shape of the identification tag.

As described above, since the necking shape containing the particles is easily reproduced by the producer of the identification tag and is difficult to reproduce by a third party other than the producer, the identification tag can be preferably used as a security tag used for determining the authenticity of a product according to an exemplary aspect.

For example, it is considered that the authenticity of a brand-name product can be determined by attaching to the brand-name product the identification tag including a specific necking shape as the information to be read and reading the necking shape.

The identification tag including a specific necking shape created by a specific process as the information to be read can be utilized as a security tag that is very difficult to imitate.

According to the exemplary aspect, the particles used for the identification tag preferably contain a metal. Examples of the metal-containing particles include metal particles (e.g., single metal particles or metal alloy particles). Examples of the metal particles include copper, silver, nickel, and tin particles, or alloy particles of these metals. The metal particles can form the necking shape by heating or the like. As the metal particles, coated powder obtained by coating particles of a first metal with a second metal can also be used.

The particles used for the identification tag preferably contain a metal oxide, a metal nitride, or a metal carbide according to various exemplary aspects.

As the metal oxide-containing particles (metal oxide particles), particles forming the necking shape can be used. Examples thereof include barium titanate, alumina, titanium oxide, ferrite, lead zirconate titanate, strontium titanate, forsterite, zirconium oxide, steatite, cordierite, sialon, and silica.

Examples of the metal nitride-containing particles (metal nitride particles) include silicon nitride and aluminum nitride.

Examples of the metal carbide-containing particles (metal carbide particles) include silicon carbide.

In these examples, silicon is regarded as a metal for purposes of this disclosure.

When the particles are the metal-containing particles or the metal oxide, metal nitride, or metal carbide-containing particles, the necking shape of the particles does not change over a long period of time because of their excellent abrasion resistance and excellent environmental resistance, such as heat resistance, light resistance, acid resistance, and the like. Therefore, the particles are configured to function as the identification tag over a long period of time.

Resin particles can also be used as the particles. When the resin particles are used, the identification tag can be produced at low cost. The use of the resin particles is preferable when the period of use as the identification tag is short. Examples of the resin particles include polyolefin particles (e.g., polyethylene particles, polypropylene particles, etc.), polyester particles (e.g., PET particles, etc.), fluororesin particles (e.g., PTFE particles, etc.), silicone resin particles, and acrylic resin particles.

In the identification tag of the present invention, the necking shape containing the particles is used as the information to be read. Hereinafter, an example of a method for reading the necking shape will be described. The method for reading the necking shape by the following method is also a part of the method for reading an identification tag of the present invention.

Particle shapes and necking shapes illustrated in the following drawings schematically show particle shapes and necking shapes in a photograph taken with a microscope.

According to an exemplary aspect, the necking shapes of the particles can be read using an electron microscope. However, it is noted that a device used for reading is not limited to the electron microscope and can be other types of similar image detection devices in alternative aspects.

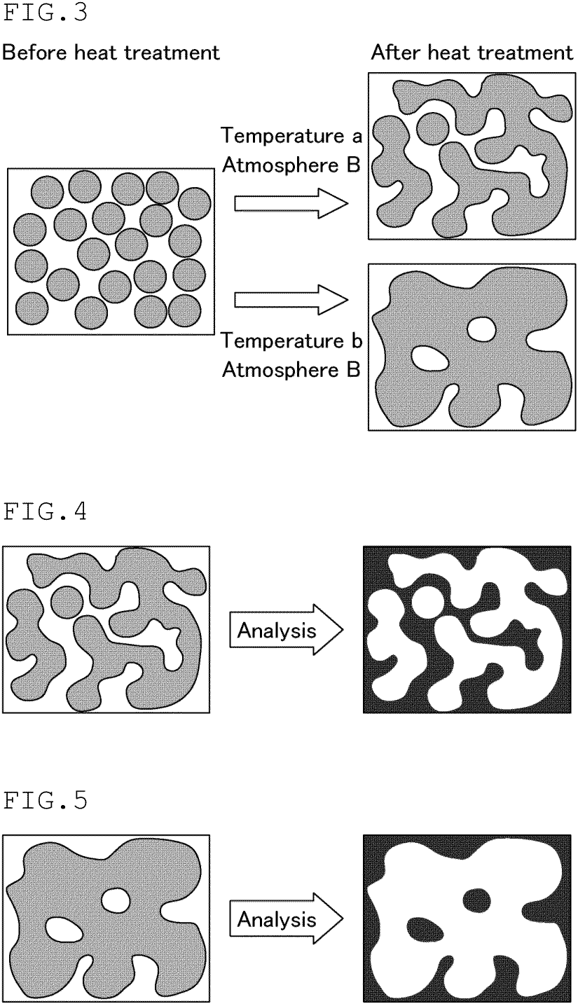

FIG. 3 is a schematic view illustrating an example of correspondence between different heat treatment conditions and the necking shapes.

The left side of FIG. 3 illustrates particles before heat treatment. The upper right of FIG. 3 illustrates the necking shape containing the particles heat-treated at a heat treatment temperature a, and the lower right illustrates the necking shape containing the particles heat-treated at a heat treatment temperature b different from the heat treatment temperature a. A heat treatment atmosphere is the same (i.e., atmosphere B) . An example of reading information from the two necking shapes will be described.

FIG. 4 is a schematic view illustrating an example in which the necking shape illustrated in the upper right of FIG. 3 is analyzed by image processing. FIG. 5 is a schematic view illustrating an example in which the necking shape illustrated in the lower right of FIG. 3 is analyzed by image processing. The left sides of FIG. 4 and FIG. 5 illustrate regions having specific areas of the micrograph, and the areas in FIG. 4 and FIG. 5 are the same.

FIG. 6 is a drawing illustrating an example in which a portion surrounded by a dotted line in the electron micrograph illustrated in FIG. 2 is binarized by image processing.

Images (i.e., the micrograph images) illustrated on the left sides of FIG. 4 and FIG. 5 are binarized into white and black using image processing software. The binarized images are images illustrated on the right sides of FIG. 4 and FIG. 5. An actual image is a black-and-white image as illustrated in FIG. 6.

In an exemplary aspect, the number of white regions in the binarized image is counted. The number of white regions is the number of particles per specific area, which is three in FIG. 4 and one in FIG. 5. The number of particles per specific area is a content of the necking shapes. The value of the content of the necking shapes is an example of the information to be read included in the necking shape. Identification tags having the necking shapes in FIG. 4 and FIG. 5, in which the content of the necking shapes is different, are distinguished as different identification tags.

Alternatively, only one of the necking shapes in FIG. 4 and FIG. 5 having different necking shapes may be distinguished as the identification tag, and the other may not be distinguished as the identification tag. That is, only one in which the necking shape satisfies predetermined conditions may be used as the identification tag.

As another information obtained from the necking shape, a circularity, an aspect ratio, an envelope degree, and the like can be used.

In order to obtain the circularity, the aspect ratio, and the envelope degree of the necking shape, the necking shape may be divided into particle units. Existing image processing methods can be used as the image processing method as would be understood to one skilled in the art.

In general, the circularity is an index indicated by “circularity = 4πS/L² (S is an area, and L is a perimeter)”. The circularity is 1 in the case of a perfect circle, and the circularity closer to 1 means that the circularity is closer to the perfect circle.

The aspect ratio is an index indicated by a ratio of a long axis/a short axis of a figure.

For purposes of this disclosure, the envelope degree is an index indicated by “envelope perimeter/actual perimeter”.

The image processing of the necking shape may be performed by an operator visually checking the image and using image processing software. In this case, the operator visually distinguishes the necking shape from other portions. The operator may also manually perform the following region division processing.

According to exemplary aspects, analysis using artificial intelligence may also be used in image processing. For example, the following region division processing can be performed using artificial intelligence. The analysis using artificial intelligence may be used to distinguish the necking shape from other portions in the image. In this case, a learned model obtained by using an image including a necking shape as training data is created in advance, and an image as a target of image processing is input to the learned model, whereby it is possible to determine the necking shape. In addition, processing by a convolutional neural network may also be used as preprocessing of the analysis of the necking shape.

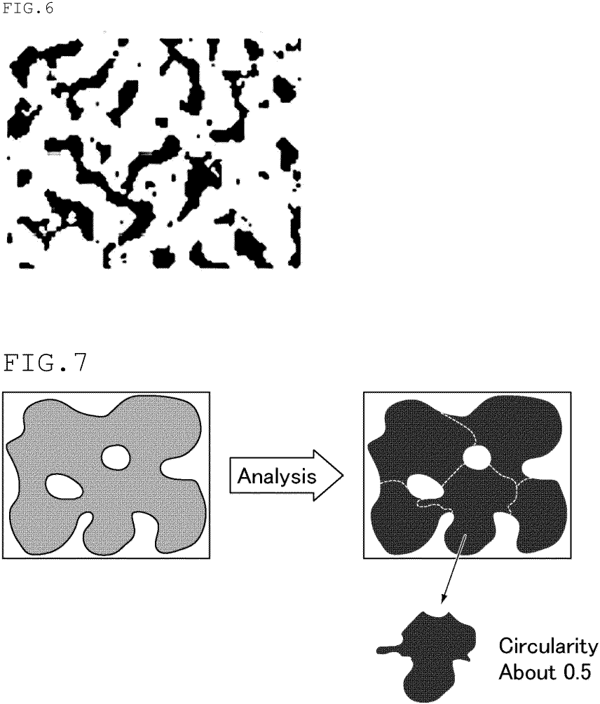

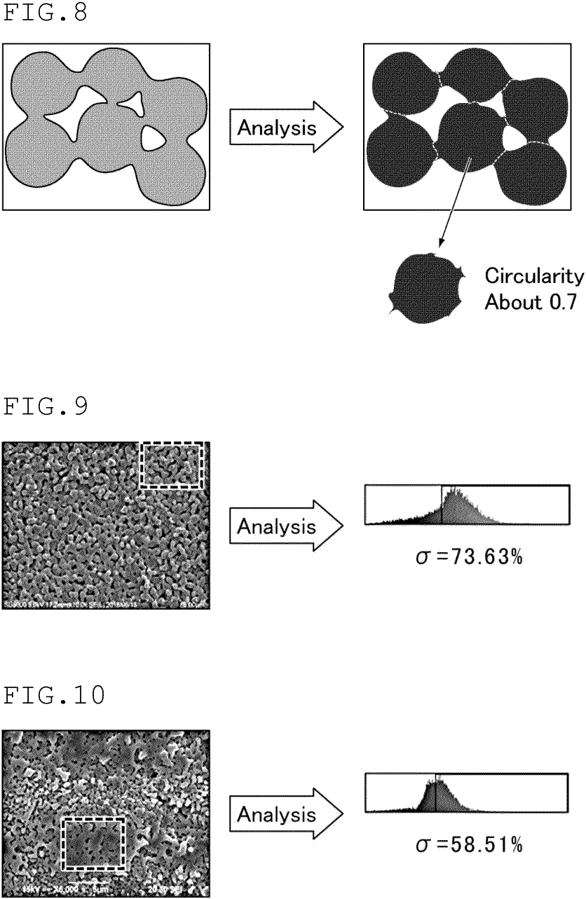

FIG. 7 and FIG. 8 are schematic views illustrating examples in which the necking shape is divided using a watershed. The watershed is one of region division methods, and is a method of dividing a region by distinguishing a joint between adjacent objects that are likely to be connected in binarization processing.

As shown, the right side of FIG. 7 illustrates that an image on the left side is divided into five regions as a result of division by the watershed. A circularity of about 0.5 is obtained in the example illustrated in FIG. 7 when the circularity is obtained by regarding each of the five regions as one particle.

The right side of FIG. 8 illustrates that an image on the left side is divided into six regions as a result of division by the watershed. A circularity of about 0.7 is obtained in the example illustrated in FIG. 8 when the circularity is obtained by regarding each of the six regions as one particle.

When the circularity of each particle corresponding to each of the plurality of regions is obtained in this manner and the average thereof is obtained, the circularity of the necking shape is obtained. The value of the circularity is also an example of the information to be read included in the necking shape.

In another exemplary aspect, the aspect ratio and the envelope degree of the particles forming the necking shape can also be obtained by dividing the necking shape similarly to the circularity.

For purposes of this disclosure, the envelope degree is obtained as “envelope perimeter/actual perimeter”. Particles obtained by dividing the necking shape may be used as the particles for obtaining the envelope degree, or the whole particle of the necking shape (for example, in the case of FIG. 7, the number of particles is considered to be one) may be used as one particle.

As another information obtained from the necking shape, luminance information in the microscopic image of the necking shape can be used.

FIG. 9 and FIG. 10 are schematic views illustrating examples in which luminance information is analyzed from an electron micrograph.

The left side of FIG. 9 illustrates an electron micrograph of a necking shape obtained by heat treatment by heater heating. The left side of FIG. 10 illustrates an electron micrograph of a necking shape obtained by heat treatment by laser heating.

Results of obtaining luminance distributions of pixels included in the images for regions surrounded by dotted lines in FIG. 9 and FIG. 10 are illustrated on the right sides. In FIG. 9, black and white tend to be separated, and a standard deviation σ indicating the luminance distribution is 73.63%. On the other hand, in FIG. 10, a difference in color is small, and the standard deviation σ indicating the luminance distribution is 58.51%. That is, it can be said that the necking shape illustrated in FIG. 10 has a smaller luminance variation.

Such luminance information (e.g., luminance variation information) is also an example of the information to be read included in the necking shape.

The identification tag may include another information other than the information on the necking shape. By including the information other than the information on the necking shape in addition to the information on the necking shape, the identification tag including more types of information is obtained.

Examples of the information other than the information on the necking shape include at least one of information on composition and information on a crystal structure of the particles.

Examples of the information on the composition of the particles include elemental analysis results of elements forming the particles.

As a method for performing elemental analysis, a method such as elemental analysis by EDX, elemental analysis by WDS, elemental analysis by XRF, or elemental analysis by ICP can be used according to various exemplary aspects.

Moreover, a device is preferably used in which an imaging device and an element analyzer are combined, such as SEM-EDX, because the analysis of the particle shape and the analysis of the composition and/or crystal structure of the particles can be performed simultaneously.

Examples of the information on the crystal structure of the particles include information on a crystallization rate of the particles, a full width at half maximum for a specific diffraction angle, and a phase. As a method of crystal structure analysis, analysis by XRD, Raman spectroscopy, UV-VIS spectral analysis, and the like can be used.

Analysis by a fluorescence spectrophotometer may also be performed.

The elemental analysis may be performed on the identification tag separated from an article to which the identification tag is attached. Some type of analysis needs to be performed by preparing a solution containing the particles included in the identification tag, which results in a destructive inspection of the identification tag.

Since the identification tag can be used as the security tag used for authenticity determination, it can be said that the identification tag can include a manufacturer of a product as the information to be read. Other examples of the information that can be included in the identification tag include product number display (e.g., model number display), lot display (e.g., serial number display), and manufacturing place display. The necking shape containing the particles forming the identification tag has a shape corresponding to these pieces of information. By associating the necking shape and the information indicated by the shape in a reading device, various information can be obtained, such as product number display, lot display, and manufacturing place display from the necking shape.

According to an exemplary aspect, the method for reading an identification tag includes distinguishing a type of an identification tag by information on a necking shape included in the identification tag of the present invention.

The method for reading the necking shape is as described above.

In the method for reading an identification tag of the present invention, the necking shape containing the particles is read using a microscope, such as an electron microscope as described above. Meanwhile, a library is prepared in which the necking shape and the type of the identification tag are associated with each other. By comparing the read necking shape detected by the microscope with the above library, it is possible to distinguish whether or not the necking shape falls under the identification tag and/or distinguish the type of the identification tag.

Next, the method for producing an identification tag will be described.

According to an exemplary aspect, the method for producing an identification tag uses particles as tag information and includes performing heat treatment of a composition containing the particles to generate a necking shape containing the particles.

As described above, the necking shape containing the particles included in the identification tag has a shape in which the particles are joined together. In the method for producing an identification tag, the identification tag is produced by determining the necking formation conditions so that the necking shape has a predetermined shape, and generating the necking shape containing the particles by the heat treatment.

A method of determining the necking shape includes a method of determining conditions before the heat treatment and a method of determining conditions of the heat treatment.

As the method of determining the conditions before the heat treatment, there is a method of adjusting pretreatment conditions of the particles before the heat treatment to produce different types of identification tags and to change the necking shape after the heat treatment.

As the pretreatment conditions of the particles, at least one selected from the group consisting of composition of the particles, crystal structures of the particles, surface states of the particles, particle sizes of the particles, or shapes of the particles can be used.

When the composition of the particles or the crystal structures of the particles are different, a melting temperature or a softening point (e.g., temperature) changes. Therefore, even under the same heat treatment conditions, different necking shapes are obtained.

Moreover, the particles may be mixed with grinding media in preparing the composition. The particle sizes of the particles and the shapes of the particles can be adjusted by adjusting the type and size of these grinding media and the number of revolutions of a ball mill. The adjustment of the particle sizes of the particles includes not only adjustment of an average particle size, but also adjustment of a particle size distribution. The necking shape also differs depending on whether the particle size distribution is sharp or broad.

When the particles are metal particles, the necking shape can be changed by performing surface treatment of the particles to change the surface states of the particles.

As a surface treatment method, a typical metal particle surface treatment method, such as wet, dry, chemical treatment, physical treatment, and the like, can be used.

It should be appreciated that changing one or more of these conditions changes the necking shape.

As another method of determining the conditions before the heat treatment, there is a method of changing the necking shape after the heat treatment by adjusting pretreatment conditions of the composition before the heat treatment, to produce different types of identification tags. The composition before the heat treatment contains the particles and components other than the particles.

As the pretreatment conditions of the composition, a makeup of the components other than the particles contained in the composition and/or molding conditions of the composition can be used.

Examples of the components other than the particles contained in the composition include a binder, a dispersant, a plasticizer, and an antifoaming agent. Changing types, blending amounts, and dispersion states of these components changes the necking shape.

Examples of the molding conditions of the composition include conditions of drying and particle size regulation of the composition, and conditions of equipment at the time of pressure molding, a mold, a molding pressure, and the like. Examples of a molding method include press molding, injection molding, extrusion molding, and sheet molding. Changing these conditions changes the necking shape.

There is also a method of changing the necking shape after the heat treatment by adjusting the heat treatment conditions, to produce different types of identification tags.

Even when the same composition is used as the composition containing the particles, the necking shape can be changed by changing the heat treatment conditions.

Examples of conditions for adjusting the heat treatment conditions include conditions of a heating method, such as whether the heat treatment is performed in a heater furnace or in laser heating equipment. For example, a microwave, a laser, an infrared heater, a far-infrared heater, an arc plasma, induction heating, resistance heating by current or voltage application, heat generation during a chemical reaction, or heat transfer by contact with a heat source can be used as a heat source. Alternatively, the heat treatment may be performed two or more times, in which different heating methods and heating conditions may be used.

Examples of the heat treatment conditions include conditions such as a heat treatment temperature (e.g., a highest reachable temperature), a heat treatment time (e.g., a retention time at the highest reachable temperature), a profile of a temperature rise/temperature drop, a heat treatment atmosphere (e.g., conditions such as the air, a low oxygen concentration, and an inert gas), and a type of member of a sheath used for the heat treatment.

FIG. 9 and FIG. 10 described above illustrate a difference in the necking shape depending on the heating method. FIG. 9 illustrates the necking shape obtained by the heat treatment by heater heating, and FIG. 10 illustrates the necking shape obtained by the heat treatment by laser heating. It is apparent from the difference between the two figures that the necking shapes are different.

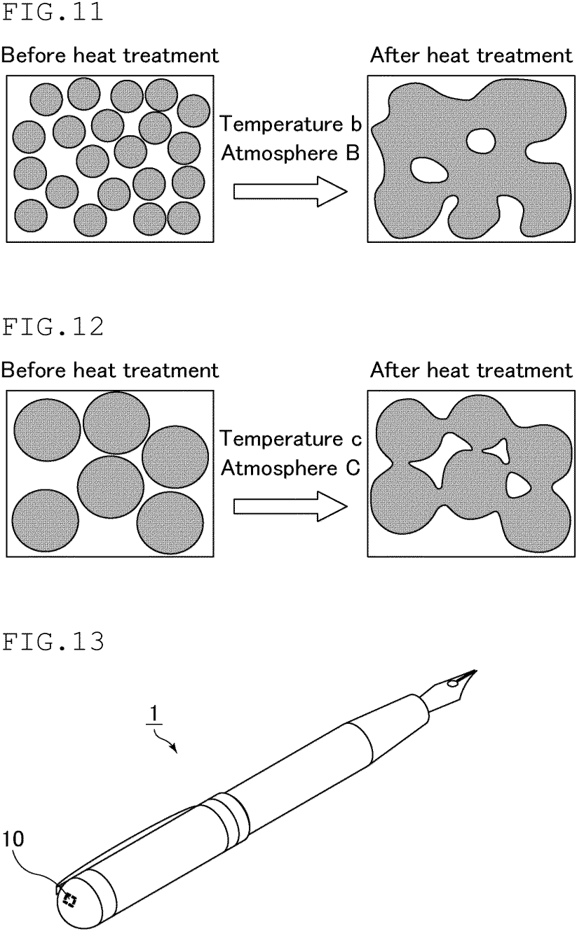

FIG. 11 and FIG. 12 are schematic views illustrating examples of correspondence between different pretreatment conditions and heat treatment conditions, and the necking shapes.

As illustrated on the left sides of FIG. 11 and FIG. 12, the particles before the heat treatment have a relatively small particle size in FIG. 11, while the particles before the heat treatment have a relatively large particle size in FIG. 12.

As a result of heat treatment of these particles under different heat treatment conditions (FIG. 11 illustrates a heat treatment temperature b and a heat treatment atmosphere B, and FIG. 12 illustrates a heat treatment temperature c and a heat treatment atmosphere C), the necking shapes as illustrated on the right sides of FIG. 11 and FIG. 12 are obtained.

In the necking shape illustrated in FIG. 11, the shapes of the particles before the heat treatment do not remain much, and a degree of melting of the particles is large. On the other hand, in the necking shape illustrated in FIG. 12, a structure derived from the shapes of the six particles before the heat treatment remains, and the necking shape joined by connecting the six particles by neck portions is obtained.

As described above, FIG. 3 illustrates the example in which the same composition is used to form the different necking shapes by the different heat treatment conditions.

As also described above, different necking shapes can be formed by adjusting the necking formation conditions. There are many conditions for determining the necking shape, and only the producer of the identification tag can know the conditions. Therefore, it is difficult to know the necking formation conditions from the necking shape.

Since the different types of necking shapes can be generated by adjusting the necking formation conditions, the number of types of identification tags can be increased.

From the above description, by using the method for producing an identification tag of the present invention, many types of identification tags can be produced in a method that cannot be known by a third party. Such an identification tag can be utilized as the security tag that is highly difficult to imitate.

By attaching the identification tag of the present invention to an article, the identification-tagged article can be obtained.

An identification-tagged article of the present invention includes an article and the identification tag of the present invention attached to the article.

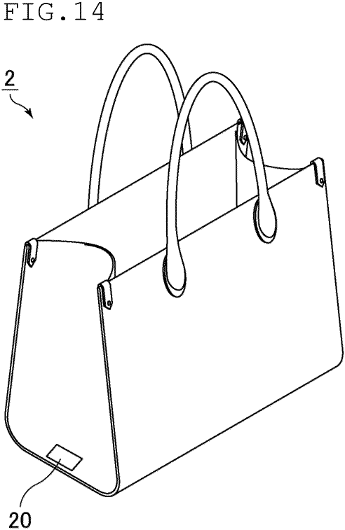

FIG. 13 and FIG. 14 are perspective views schematically illustrating examples of the identification-tagged article.

An identification-tagged article 1 illustrated in FIG. 13 includes an identification tag 10 in which an ink containing the particles is applied by printing to a part of a fountain pen as the article.

It is noted that a method of applying the ink containing the particles is not limited to printing, and examples thereof include a method of bringing a part of the article into contact with the ink containing the particles, and a method of application by brush coating or the like.

Since the particles contained in the ink have the necking shape, the information can be imparted to the article by the identification tag.

An identification-tagged article 2 illustrated in FIG. 14 includes an identification tag 20 in which a sticking object including the particles is stuck on a part of a bag as the article.

Moreover, the identification-tagged article can be obtained by sticking the sticking object to which the particles are attached as the identification tag, on the article to which the identification tag is to be attached.

As the sticking object, a sticker (e.g., a seal) in which the ink containing the particles is applied to one surface side of a base material and an adhesive or a pressure-sensitive adhesive is applied to the other surface side can be used. When the article is a fibrous product, such as a bag, clothing, and the like, the identification tag may be attached by sewing a fabric to the article as the sticking object. The ink containing the particles is applied to the fabric. The fabric to which the ink containing the particles is applied in such an application method falls under the sticking object.

The ink containing the particles used for attaching the identification tag to the article can be produced by mixing the particles having the necking shape with a solvent, a dispersant, a binder resin, and the like. The particles having the necking shape are the particles that have been subjected to the heat treatment and produced by the method for producing an identification tag of the present invention, and can be obtained by grinding or disintegrating a molded body after the heat treatment to such an extent that the necking shape of the particles can be identified. The molded body itself can be treated as an individual particle by heat treatment of a sufficiently small molded body.

Moreover, it should be appreciated that the identification tag may be disposed at a position where the identification tag is easily visually recognized in the appearance of the article, or may be disposed at a position where the identification tag is hardly visually recognized (cannot be visually recognized) from the appearance of the article.

When the identification tag is used as a security tag, the identification tag is disposed at a position where the identification tag is easily visually recognized in the appearance of the article, so that a third party who intends to manufacture a counterfeit product needs to counterfeit the identification tag as well. The idea is to prevent imitation by clearly showing that the identification tag is attached.

On the other hand, by disposing the identification tag at a position that is difficult to visually recognize (e.g., not visible) in the appearance of the article, the influence of the identification tag on the appearance (i.e., the design or ornamental aspect) of the article can be eliminated. If a third party who intends to manufacture a counterfeit product is not aware of the presence of the identification tag, the third party does not imitate the article including the portion of the identification tag, so that a complete counterfeit product including the identification tag is not manufactured.

In general, the identification tag may be attached to any article including products that are likely to be imitated or forged. Examples thereof include brand-name products (bags, wallets, jewelry, cosmetics, wristwatches, clothing, stationery, etc.), CDs, DVDs, game software, toys, pharmaceuticals, medical devices, banknotes, electronics, substrates, modules, electrical appliances, cameras, OA equipment, furniture, and conveyance materials and packing materials for various products.

REFERENCE SIGNS LIST

| | |
|---|---|
| 1, 2 | identification-tagged article |
| 10, 20 | identification tag |

What is claimed:

1. An identification tag comprising:
particles having a necking shape that are configured as readable tag information,
wherein the identification tag is configured to be attached to an article.

2. The identification tag according to claim 1, wherein the particles are metallic particles.

3. The identification tag according to claim 1, wherein the particles comprise at least one of a metal oxide, a metal nitride, and a metal carbide.

4. The identification tag according to claim 1, wherein the readable tag information includes additional information on the particles other than the readable tag information on the necking shape.

5. The identification tag according to claim 4, wherein the additional information on the particles is at least one of information on a composition and information on a crystal structure of the particles.

6. The identification tag according to claim 1, wherein the article is a fibrous article.

7. A method for producing an identification tag, the method comprising:
performing heat treatment of a composition containing particles to generate a necking shape of the particles that is configured as readable tag information; and
configuring the identification tag to be attached to an article.

8. The method for producing an identification tag according to claim 7, further comprising changing the necking shape by adjusting a pretreatment condition of the particles before the heat treatment to produce different types of identification tags.

9. The method for producing an identification tag according to claim 8, wherein the pretreatment condition of the particles is at least one selected from the group consisting of composition of the particles, a crystal structure of the particles, a surface state of the particles, a particle size of the particles, and a shape of the particles.

10. The method for producing an identification tag according to claim 7, further comprising changing the necking shape by adjusting a pretreatment condition of the composition before the heat treatment to produce different types of identification tags.

11. The method for producing an identification tag according to claim 10, wherein the pretreatment condition of the composition is at least one of a makeup of components other than the particles contained in the composition and a molding condition of the composition.

12. The method for producing an identification tag according to claim 7, further comprising changing the necking shape by adjusting a condition of the heat treatment to produce different types of security tags.

13. The method for producing an identification tag according to claim 7, further comprising:
applying an ink containing the particles by printing to a part of a fountain pen as the article; and
imparting the identification tag to the article.

14. A method for reading an identification tag, the method comprising:
distinguishing a type of the identification tag by information on the necking shape included in the identification tag according to claim 1.

15. An identification-tagged article comprising:
an article; and
an identification tag including particles having a necking shape that is configured as readable tag information and is attached to the article.

16. The identification-tagged article according to claim 15, wherein the article is a fibrous article.

17. The identification-tagged article according to claim 15, further comprising an ink that contains the particles that is printed to a part of a fountain pen as the article.

18. The identification-tagged article according to claim 15, wherein the particles are metallic particles.

19. The identification-tagged article according to claim 15, wherein the particles comprise at least one of a metal oxide, a metal nitride, and a metal carbide.

20. The identification-tagged article according to claim 15,
wherein the readable tag information includes additional information on the particles other than the readable tag information on the necking shape, and
wherein the additional information on the particles is at least one of information on a composition and information on a crystal structure of the particles.
